(19) United States
(12) Patent Application Publication
(10) Pub. No.: US 2010/0206809 A1
(43) Pub. Date: Aug. 19, 2010

(54) METHOD AND APPARATUS FOR TREATING ORGANIC MATTER-CONTAINING WATER

(75) Inventor: Nozomu Ikuno, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: KURITA WATER INDUSTRIES LTD., Shinjuku-ku (JP)

(21) Appl. No.: 12/733,397

(22) PCT Filed: Aug. 7, 2008
(86) PCT No.: PCT/JP2008/064236

§ 371 Date: Feb. 26, 2010

(30) Foreign Application Priority Data
Aug. 29, 2007 (JP) 2007-222758

(51) Int. Cl. C02F 9/08; C02F 1/42; C02F 1/66; C02F 1/76; C02F 1/44; C02F 101/30

(52) U.S. Cl. 210/638; 210/206

(57) ABSTRACT

There are provided a method and an apparatus for treating organic matter-containing water, the method and apparatus being capable of inhibiting the multiplication of microorganisms in an activated carbon column and a reverse osmosis membrane separator and performing stable treatment over long periods of time in a process including active carbon treatment and subsequent RO membrane separation treatment with an ultrapure water production system for use in electronic device manufacturing plants. The method for treating organic matter-containing water includes an oxidizer addition step of adding an oxidizer to organic matter-containing water, an activated carbon treatment step of treating the organic matter-containing water that has been subjected to the oxidizer addition step with activated carbon, and a reverse osmosis membrane separation step of feeding the organic matter-containing water that has been subjected to the activated carbon treatment step into a reverse osmosis separation means, in which a combined-chlorine-based oxidizer is used as the oxidizer.

### FIELD OF INVENTION

The present invention relates to a method and an apparatus for treating organic matter-containing water, the method and the apparatus being suitable for use in systems for producing ultrapure water used in electronic-device-manufacturing plants and treatment facilities for wastewater from electronic-device-manufacturing plants.

### BACKGROUND ART

In electronic-device-manufacturing plants, ultrapure water is used as rinse water. Ultrapure water is typically manufactured by a process including activated carbon treatment and subsequent reverse osmosis (RO) membrane separation treatment from industrial water or wastewater from a plant as raw water.

The activated carbon treatment aims to remove an oxidizer, organic matter, chromaticity, or the like in the raw water. The organic matter is adsorbed and concentrated on the activated carbon. The organic matter serves as an energy source, so that the activated carbon column has an environment in which microorganisms are easily grown. In general, microorganisms cannot be present in the presence of an oxidizer. Thus, microorganisms are not present in activated carbon feed water exposed to the oxidizer. However, regarding a mechanism for the removal of the oxidizer with activated carbon, a catalytic decomposition reaction on the surface of activated carbon proceeds in the upper portion of the column. Thus, the oxidizer is not present in the middle and lower portions of the activated carbon column. Accordingly, the inside of the activated carbon column becomes a breeding ground for microorganisms. In general, about 10³ cells/ml to about 10⁷ cells/ml of bacterial cells leak from the activated carbon column.

The activated carbon column is an essential unit serving as a means configured to remove an oxidizer and organic matter in an ultrapure water production system. The activated carbon column tends to become a breeding ground for microorganisms as described above. Thus, in the case of a high concentration of organic matter that flows into the activated carbon column, microorganisms from the activated carbon column can cause biofouling on a safety filter or an RO membrane arranged at a step downstream therefrom, leading to clogging.

As a means for solving the foregoing problems, hot-water disinfection and a chlorine disinfection method have been performed to disinfect the inside of the activated carbon column.

Hot-water disinfection is a method in which hot water with a temperature of 80° C. or higher is passed and held through the activated carbon column for one hour or more. However, it is necessary to pass and held hot water with a high temperature for a long time.

As chlorine disinfection, Japanese Unexamined Patent Application Publication No. 5-64782 discloses a method for performing back washing with back wash water to which NaClO is added. In this method, NaClO is decomposed on a surface of a lower layer of an activated carbon column into which the back wash water is fed. Thus, NaClO is not delivered to the whole of the activated carbon column, failing to provide a sufficient disinfection effect.

In recent years, environmental criteria and water quality criteria have become more stringent. It would be desirable to highly clarify final effluent. To solve shortage of water, advanced wastewater treatment techniques have been required for the recovery and recycling of various types of wastewater.

RO membrane separation treatment enables us to effectively remove impurities (ions, organic matter, fine particles, and so forth) and thus has recently been employed in many fields. For example, in the case where high- or low-concentration-organic-matter-containing wastewater containing acetone, isopropyl alcohol, and so forth emitted from semiconductor manufacturing processes is recovered and recycled, a method is widely employed in which the wastewater was first subjected to biological treatment to remove organic components, and then the resulting biologically treated water is subjected to RO membrane treatment for clarification (for example, Japanese Unexamined Patent Application Publication No. 2002-336886).

However, in the case where the biologically treated water is passed through the RO membrane separator, the RO membrane can be clogged with microbial metabolites formed from the decomposition of organic matter by microorganisms, thereby reducing the flux.

In the case where the organic matter-containing wastewater is directly fed into the RO membrane separator without employing biological treatment, the inside of the RO membrane separator becomes a breeding ground for microorganisms because of a high TOC concentration of the wastewater fed into the RO membrane separator. Thus, for the purpose of inhibiting biofouling in the RO membrane separator, a large amount of a slime control agent is added to the organic matter-containing wastewater. However, a method for inhibiting biofouling at lower cost is required because the slime control agent is expensive.

Furthermore, wastewater from electronic device manufacturing facilities can contain nonionic surfactant that can adhere to the membrane of the RO membrane separator and reduce the flux. Thus, such wastewater containing nonionic surfactant cannot be subjected to RO membrane separation treatment.

As a technique for solving the foregoing problems, preventing biofouling and a reduction in flux due to the adhesion of organic matter to the membrane of an RO membrane separator to achieve stable operation over long periods of time, and effectively reducing the TOC concentration in water to provide high-quality treated water when high- or low-concentration-organic-matter-containing water from electronic device manufacturing facilities and other various fields is treated and recovered with the RO membrane separator, the inventors have proposed a method and an apparatus in which a scale inhibitor is added to organic matter-containing water, the amount of the scale inhibitor being five times the weight of calcium ions in the organic matter-containing water, an alkali agent is added to the organic matter-containing water to adjust the pH to 9.5 or more before, after, or simultaneously with the addition of the scale inhibitor, and then RO separation treatment is performed (Japanese Unexamined Patent Application Publication No. 2005-169372).

Furthermore, the inventors have proposed a method and an apparatus in which a scale inhibitor is added to wastewater, the wastewater whose pH has been adjusted to 9.5 or more is subjected to activated carbon treatment and then RO membrane separation treatment, so that the growth of microorganisms in the activated carbon column and the RO membrane separator is inhibited, thereby stably providing treated water (Japanese Patent No. 3906855). In this method, the activated carbon column is arranged to adsorb and remove an oxidizer in raw water and organic matter in the raw water.

As described above, the addition of a predetermined amount of the scale inhibitor to target water (hereinafter, also referred to as “RO feed water”) fed into the RO membrane separator and the flow of water whose pH has been adjusted to 9.5 or more into the RO membrane separator results in the prevention of biofouling and a reduction in flux due to the adhesion of organic matter to the membrane of the RO membrane separator to achieve stable operation over long periods of time and results in an effective reduction in TOC concentration in water to provide high-quality treated water.

Microorganisms cannot live in an alkaline region. Thus, the adjustment of the pH of the RO feed water to 9.5 or more can provide an environment in which although energy source is present, microorganisms cannot live in the RO membrane separator. It is possible to inhibit biofouling in the RO membrane separator without the need for the addition of a traditional expensive slime control agent.

Furthermore, the nonionic surfactant that can reduce the flux through the RO membrane is known to be detached from the membrane in a high alkaline region. It is thus possible to suppress the adhesion of the component to the RO membrane by adjusting the pH of the RO feed water to 9.5 or more.

In rare cases, TOC-containing wastewater from electronic device manufacturing facilities and so forth contains calcium ions and the like, which causes scale. under the high-pH RO operating condition in which the pH of the RO feed water is set to 9.5 or more, the presence of even a trace amount of calcium ions leads to the formation of scale such as calcium carbonate, thereby immediately causing the clogging of the RO membrane. Hence, in order to prevent the clogging of the membrane due to the scale, the scale inhibitor is added to the RO feed water, the amount of the scale inhibitor added being five or more times the weight of calcium ions in the RO feed water, thereby preventing the formation of scale.

However, in the method in which the scale inhibitor is added to organic matter-containing water, the amount of the scale inhibitor added being five or more times the weight of calcium ions in the organic matter-containing water, the alkali agent is added to the organic matter-containing water to adjust the pH to 9.5 or more before, after, or simultaneously with the addition of the scale inhibitor, and then the RO separation treatment is performed, in the case where large amounts of hardness components are present in raw water, even if a scale-dispersing agent is added, its effect of inhibiting scale is not sufficient. Thus, it is necessary to arrange a cation exchange column or softening column, reduce hardness load, and adjust the pH to an alkaline side.

In the method disclosed in Japanese Patent No. 3906855, raw water is treated with the activated carbon column, the cation exchange column or softening column, and then the RO membrane separator. In the treatment procedure, the operation of the cation exchange column or softening column cannot be performed under high alkaline conditions from the viewpoint of controlling the formation of scale in the column. It is thus necessary to operate the cation exchange column or softening column and the activated carbon column arranged upstream from them under neutral conditions. As a result, slime grows readily in the activated carbon column and the cation exchange column or softening column under the neutral conditions. In some cases, the RO membrane separator (or a safety filter for the RO membrane separator) arranged downstream is clogged with biofilms detached from the column.

To inhibit the growth of slime, it is conceivable to add a germicide to raw water. However, a common germicide such as sodium hypochlorite (NaClO) or the like is mostly removed in the activated carbon column. Thus, the disinfection effect is not provided in the cation exchange column or softening column arranged downstream from the activated carbon column, failing to inhibit the growth of slime.

Patent Document 1: Japanese Unexamined Patent Application Publication No. 5-64782

Patent Document 2: Japanese Unexamined Patent Application Publication No. 2002-336886

Patent Document 3: Japanese Unexamined Patent Application Publication No. 2005-169372

Patent Document 4: Japanese Patent No. 3906855

### SUMMARY OF INVENTION

It is an object of the present invention to provide a method and an apparatus for treating organic matter-containing water, the method and apparatus being capable of inhibiting the multiplication of microorganisms in an activated carbon column and a reverse osmosis membrane separator and performing stable treatment over long periods of time in a process including active carbon treatment and subsequent RO membrane separation treatment with an ultrapure water production system for use in electronic device manufacturing plants.

It is another object of the present invention to provide a method and an apparatus for treating organic matter-containing water, in which the method and apparatus suppress the growth of slime in an activated carbon column, a cation exchange column, or a softening column arranged before an RO membrane separator, prevent biofouling and a reduction in flux due to the adhesion of organic matter to a membrane in the RO membrane separator to achieve stable treatment over long periods of time, and efficiently reduce the TOC concentration in water to afford high-quality treated water when water containing a high or low concentration of organic matter and large amounts of hardness components from electronic device manufacturing plants and various other fields is treated and recovered with the RO membrane separator.

A method for treating organic matter-containing water according to a first aspect includes an oxidizer addition step of adding an oxidizer to organic matter-containing water, an activated carbon treatment step of treating the organic matter-containing water that has been subjected to the oxidizer addition step with activated carbon, and a reverse osmosis membrane separation step of feeding the organic matter-containing water that has been subjected to the activated carbon treatment step into a reverse osmosis separation means, in which a combined-chlorine-based oxidizer is used as the oxidizer.

According to a second aspect, the method for treating organic matter-containing water according to the first aspect is characterized in that in the oxidizer addition step, the combined-chlorine-based oxidizer is added in an amount such that the concentration of combined chlorine is 1 mg-Cl₂/L or more.

According to a third aspect, the method for treating organic matter-containing water according to the first or second aspect is characterized in that in the activated carbon treatment step, the organic matter-containing water is fed into an activated carbon column at an SV of 20 hr⁻¹ or more.

According to a fourth aspect, the method for treating organic matter-containing water according to any one of the first to third aspects further includes a hardness component removal step of feeding the organic matter-containing water that has been subjected to the activated carbon treatment step into a cation exchange means to reduce the hardness, a scale inhibitor addition step of adding a scale inhibitor to the organic matter-containing water that has been subjected to the hardness component removal step, the amount of the scale inhibitor added being five or more times the weight of calcium ions in the organic matter-containing water that has been subjected to the hardness component removal step, and a pH adjustment step of adding an alkali to the organic matter-containing water to adjust the pH of the organic matter-containing water to be fed into a subsequent reverse osmosis membrane separation means to 9.5 or more before, after, or simultaneously with the scale inhibitor addition step.

An apparatus for treating organic matter-containing water according to a fifth aspect includes an oxidizer addition means configured to add an oxidizer to organic matter-containing water, an activated carbon treatment means configured to treat the organic matter-containing water that has been passed through the oxidizer addition means with activated carbon, and a reverse osmosis membrane separation means configured to subject the organic matter-containing water that has been passed through the activated carbon treatment means to reverse osmosis membrane separation treatment, in which a combined-chlorine-based oxidizer is used as the oxidizer.

According to a sixth aspect, the apparatus for treating organic matter-containing water according to the fifth aspect is characterized in that in the oxidizer addition means, the combined-chlorine-based oxidizer is added in an amount such that the concentration of combined chlorine is 1 mg-Cl₂/L or more.

According to a seventh aspect, the apparatus for treating organic matter-containing water according to the fifth or sixth aspect is characterized in that the activated carbon treatment means is an activated carbon column and that the SV of water passing through the activated carbon column is 20 hr⁻¹ or more.

According to an eighth aspect, the apparatus for treating organic matter-containing water according to any one of the fifth to seventh aspects further includes a hardness component removal means including a cation exchange means through which the organic matter-containing water that has been passed through the activated carbon treatment means is passed, a scale inhibitor addition means configured to add a scale inhibitor to the organic matter-containing water that has been passed through the hardness component removal means, the amount of the scale inhibitor added being five or more times the weight of calcium ions in the organic matter-containing water that has been passed through the hardness component removal means, and a pH adjustment means configured to add an alkali to the organic matter-containing water to adjust the pH of the organic matter-containing water to be fed into a subsequent reverse osmosis membrane separation means to 9.5 or more before, after, or simultaneously with the scale inhibitor addition means.

According to the method and apparatus for treating organic matter-containing water, the combined-chlorine-based oxidizer inhibits the growth of viable cells in the activated carbon column and leaks in a high concentration from the activated carbon column. Thus, biofouling and a reduction in flux due to the adhesion of organic matter to a membrane (organic-matter fouling) in the RO membrane separator, which is a downstream unit, are prevented without performing new disinfection treatment after the activated carbon column. This enables us to perform stable treatment over long periods of time and efficiently reduce the TOC concentration in water to afford high-quality treated water. Furthermore, in the case where the RO membrane is subjected to disinfection treatment with the combined-chlorine-based oxidizer, the permeability of the membrane is not reduced even if the RO membrane is formed of a polyamide composite membrane having poor chlorine resistance.

An excessively small amount of the combined-chlorine-based oxidizer added results in a reduction in the amount of the combined-chlorine-based oxidizer leaking from the activated carbon column, failing to provide the effect of sufficiently inhibiting the growth of slime at downstream stages. Thus, according to the second and sixth aspects, the combined-chlorine-based oxidizer is added in an amount such that the concentration of combined chlorine is 1 mg-Cl₂/L or more, thereby resulting in a sufficient amount of leak.

In the case where water to which the combined-chlorine-based oxidizer is added is fed into the activated carbon column, when the SV of water passing therethrough is low, the combined-chlorine-based oxidizer is removed in the activated carbon column. In this case, the combined-chlorine-based oxidizer does not leak into water from the activated carbon column (hereinafter, also referred to as “activated carbon-treated water”), so that the disinfection effect is not provided at stages downstream from the activated carbon column. Thus, according to the third and seventh aspects, water is preferably fed into an activated carbon column at an SV of 20 hr⁻¹ or more.

According to the fourth and eighth aspects, the reason the pH of the RO feed water is preferably adjusted to 9.5 or more by the addition of the alkali is described below.

That is, microorganisms cannot live in an alkaline region. The adjustment of the pH of the RO feed water to 9.5 or more provides an environment in which although energy source is present, microorganisms cannot live. This results in the inhibition of biofouling in the RO membrane separator.

It is known that a nonionic surfactant that can reduce the flux is detached from the membrane in an alkaline region. A pH of the RO feed water of 9.5 or more results in the inhibition of the adhesion of the component to the RO membrane.

According to the fourth and eighth aspects, the reason the scale-dispersing agent is preferably added in an amount five or more times the weight of calcium ions in the treated water in which the hardness components have been removed is described below.

That is, ions such as calcium ions present in raw water by the cation exchange treatment. Some scale components present in the raw water form into complexes or are suspended. Such components are not removed by the cation exchange treatment, flow into the RO membrane separator, serve as nuclei that cause scale formation on the membrane. The addition of the scale inhibitor to the target water inhibits the growth of the nuclei for scale, thereby completely preventing scale trouble on the RO membrane. As described above, under the high-pH RO operating condition in which the pH of the RO feed water is set to 9.5 or more, the presence of even a trace amount of calcium ions leads to the formation of scale such as calcium carbonate, thereby immediately causing the clogging of the RO membrane. Hence, in order to prevent the clogging of the membrane due to the scale, according to the fourth and eighth aspects, the scale inhibitor is added to water in which the hardness components have been removed, the amount of the scale inhibitor added being five or more times the weight of calcium ions in the water, thereby preventing the formation of scale.

The present invention is applied to a production process of ultrapure water serving as industrial water for use in the manufacture of electronic devices. Furthermore, the present invention is effectively applied to water treatment for releasing, recovering, or recycling high- or low-concentration-TOC-containing wastewater emitted from electronic device manufacturing fields, semiconductor manufacturing fields, and other various industrial fields.

### BRIEF DESCRIPTION OF DRAWINGS

FIG. 1 is a system diagram of a method and an apparatus for treating organic matter-containing water according to an embodiment of the present invention.

FIG. 2 is a system diagram of a method and an apparatus for treating organic matter-containing water according to another embodiment of the present invention.

FIG. 3 is a graph showing a time-dependent change in the differential pressure across an RO membrane separator in Example 1 and Comparative Example 1.

### DETAILED DESCRIPTION

Embodiments of a method and an apparatus for treating organic matter-containing water according to the present invention will be described in detail below with reference to the drawings.

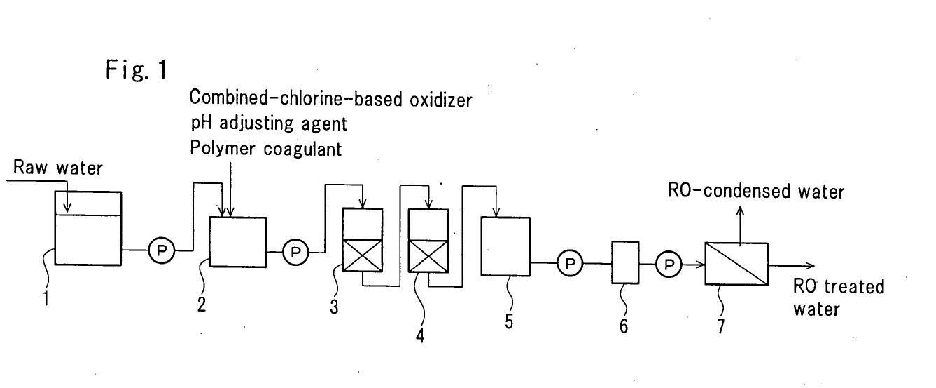

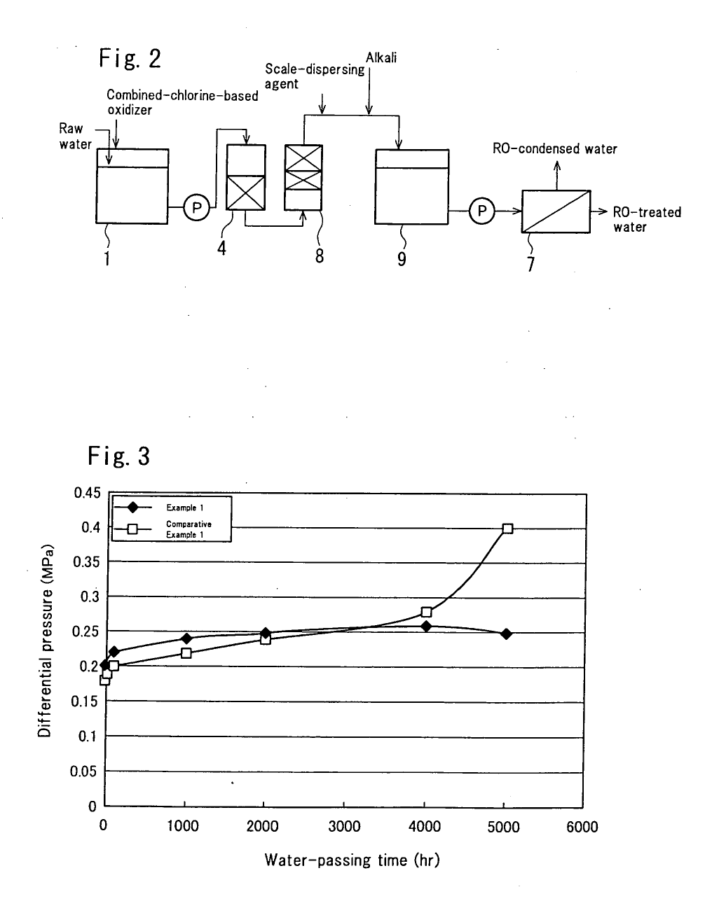

FIGS. 1 and 2 are system diagrams of a method and an apparatus for treating organic matter-containing water according to embodiments of the present invention. In the figures, P's represent pumps.

In FIG. 1, raw water (organic matter-containing water, e.g., industrial water) is fed into a coagulation tank 2 through a raw-water tank 1. A combined-chlorine-based oxidizer, a coagulant, and, optionally, a pH-adjusting agent are added thereto. The water is successively passed through a pressure filter 3, an activated carbon column 4, and a filtered water tank 5. The water is then fed into an RO membrane separator 7 through a safety filter 6 and subjected to RO membrane separation treatment.

The combined-chlorine-based oxidizer used in the present invention is not particularly limited. Inorganic combined-chlorine-based oxidizers, such as chloramines (nitrogen compounds each having a chlorine atom on nitrogen) and organic combined-chlorine-based germicides, such as chloramine T, dichloroamine T, and chloramine B, may be used. These may be used separately or in combination of two or more as a mixture.

The term “combined chlorine” of the combined-chlorine-based oxidizer used in the present invention indicates the following.

Chlorine reacts with an ammonia compound in water to form a chloramine. Monochloroamine (NH₂Cl), dichloroamine (NHCl₂), or trichloroamine (NCl₃) is formed as the chloramine, depending on the pH of water. Monochloroamine and dichloroamine are typically contained in tap water. Monochloroamine and dichloroamine are referred to as combined chlorine and have a disinfection effect.

Combined chlorine is inferior in bactericidal activity to free chlorine (the degree of bactericidal activity is HOCl>OCl⁻>inorganic chloramine>organic chloramine). Combined chlorine, however, is more stable than free chlorine and thus remains undecomposed for a long time, providing the disinfection effect. Note that chloramine B and chloramine T are trade names and have chemical names as described below.

Chloramine B (sodium N-chlorobenzenesulfonamide)

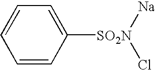

Chloramine T (sodium N-chloro-p-toluenesulfonamide trihydrate)

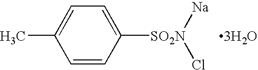

In the present invention, a prepared reagent may be used as the combined-chlorine-based oxidizer. Alternatively, since the combined-chlorine-based oxidizer is difficult to handle, a chlorine compound may be reacted in situ with an ammonia compound, for example, according to the following reaction formula, forming a combined-chlorine-based oxidizer:

NH₃+NaClO→NH₂Cl+H₂O.

Regarding the ammonia compound reacted with the chlorine compound, sulfamic acid and/or a salt thereof is practically preferred because a combined-chlorine-based oxidizer constituted by sulfamic acid and/or the salt thereof has excellent stability in water.

The chlorine compound used in the present invention is not particularly limited so long as it reacts with an ammonia compound to form a combined-chlorine-based oxidizer. Examples of the chlorine compound include hypochlorous acid, alkali metal salts of hypochlorous acid, and chlorine (Cl₂).

The combined-chlorine-based oxidizer is added in such a manner that the concentration of the combined chlorine is preferably 1 mg-Cl₂/L or more and more preferably 1 to 50 mg-Cl₂/L. In general, the combined-chlorine-based oxidizer is not readily decomposed and removed by activated carbon. Thus, the combined-chlorine-based oxidizer leaks readily from the subsequent activated carbon column 4, thereby providing a bactericidal effect. A concentration of less than 1 mg-Cl₂/L or an SV of water passing through the activated carbon column 4 of less than 20 hr⁻¹ results in an extremely low concentration of the oxidizer leaking from the activated carbon column 4, causing difficulty in inhibiting the growth of slime in the activated carbon column 4 or a subsequent unit (e.g., a softening column 8 shown in FIG. 2). Furthermore, an excessively large amount of the combined-chlorine-based oxidizer added is not preferred from the viewpoint of reagent cost. Thus, the concentration of the combined-chlorine-based oxidizer is preferably 50 mg-Cl₂/L or less.

In the case where suspended solids are present in raw water, as shown in FIG. 1, preferably, the pH is adjusted to an optimum coagulation pH range before or after the addition of the combined-chlorine-based oxidizer. After the addition of a coagulant, coagulation filtration or the like is performed to remove suspended solids. Then the water is passed through the activated carbon column. In this case, any coagulation filtration means may be employed without limitation so long as suspended solids contained in raw water can be removed by an operation, for example, pressure filtration, gravity filtration, microfiltration, ultrafiltration, pressure flotation, or sedimentation.

Activated carbon used in the activated carbon column 4 through which the raw water that has been subjected to the addition of the combined-chlorine-based oxidizer and, optionally, subjected to treatment for removing the suspended solids is passed is not particularly limited but may be made from coal, coconut shells, or the like. Furthermore, the shape is not particularly limited. For example, granular activated carbon and spherical activated carbon may be used.

The type of the activated carbon column 4 is not particularly limited. A fluidized bed, a fixed bed, and so forth may be used. The fixed bed is preferred from the viewpoint of suppressing the leak of powdered coal.

As described above, an excessively low SV of water passing through the activated carbon column 4 causes removal of the combined-chlorine-based oxidizer in the activated carbon column 4, reducing the concentration of the combined-chlorine-based oxidizer in the activated carbon-treated water. As a result, the effect of inhibiting the growth of slime is not provided. Thus, the SV of water passing through the activated carbon column 4 is preferably set to 20 hr⁻¹ or more. However, an excessively high SV of water passing through the activated carbon column 4 fails to sufficiently provide the effect of removing an oxidizer originating from the raw water in the activated carbon column 4. Thus, the SV of water passing through the activated carbon column 4 is preferably 50 hr⁻¹ or less and particularly preferably 20 to 40 hr⁻¹.

In the present invention, treatment with activated carbon may be performed in such a manner that an oxidizer originating from the raw water is removed. The treatment is not limited to the use of the activated carbon column. In view of treatment efficiency, the activated carbon column is preferably used.

An RO membrane used in the present invention is not particularly limited. It is preferred to use a polyvinyl alcohol-based low-fouling RO membrane having desalination performance in which a salt rejection rate (hereinafter, simply referred to as “salt rejection rate”) is 95% or more when 1500 mg/L saline with a pH of 7 is subjected to RO membrane separation treatment at 1.47 MPa and 25° C.

In FIG. 2, the combined-chlorine-based oxidizer and, optionally, the pH-adjusting agent are added to raw water fed through the raw-water tank 1. The water is passed through the activated carbon column 4 and then the softening column 8. Next, a scale-dispersing agent is added in such a manner that the concentration of the scale-dispersing agent is five or more times the concentration of calcium ions in water passing from the softening column 8 (hereinafter, also referred to as “softened water”). An alkali is then added to adjust the pH to 9.5 or more. The water is passed through an intermediate tank 9. The water with a high pH is fed into the RO membrane separator 7 and subjected to RO membrane separation treatment.

In FIG. 2, the addition of the combined-chlorine-based oxidizer and treatment in the activated carbon column 4 are performed as those shown in FIG. 1.

Any ion-exchange resin, e.g., an H-type cation exchange resin in which an ion-exchange group is H, Na-type cation exchange resin in which an ion-exchange group is Na, or a chelating resin, for use in the softening column 8 through which activated-carbon-treated water is passed may be used without limitation so long as it can remove hardness components in raw water. Furthermore, the type of the softening column 8 is not particularly limited. A fluidized bed, a fixed bed, and so forth may be used.

In the present invention, treatment for removing the hardness components may be performed with a cation exchange column in place of the softening column. Furthermore, the treatment is not limited to the use of a column-shaped unit. Like the activated carbon column, the column-shaped unit is preferably used in view of treatment efficiency.

The SV of water passing through the softening column 8 or the cation exchange column is not particularly limited. The treatment is usually performed at an SV of 10 to 40 hr⁻¹ in view of treatment efficiency and the effect of removing the hardness components.

As a scale inhibitor added to the treated water from the softening column 8, a chelate-type scale inhibitor, which dissociates to readily form a metal complex, for example, ethylenediaminetetraacetic acid (EDTA) or nitrilotriacetic acid (NTA), is suitably used. Other examples of a material that can be used include low-molecular-weight polymers, such as (meth)acrylic acid polymers and salts thereof and maleic acid polymers and salts thereof; phosphonic acid and phosphonate, such as ethylenediaminetetramethylenephosphonic acid and salts thereof, hydroxyethylidenediphosphonic acid and salts thereof, nitrilotrimethylenephosphonic acid and salts thereof, and phosphonobutane tricarboxylic acid and salts thereof; and inorganic polyphosphoric acids and inorganic polymeric phosphates, such as hexametaphosphoric acid and salts thereof and tripolyphosphoric acid and salts thereof. These scale inhibitors may be used alone or in combination of two or more.

In the present invention, the amount of the scale inhibitor added is five or more times the weight of the concentration of calcium ions in water (water to which the scale inhibitor will be added) passing from the softening column 8. In the case where the amount of the scale inhibitor added is less than five times the weight of the concentration of calcium ions in the softened water, the effect of the addition of the scale inhibitor is not sufficiently provided. An excessively large amount of the scale inhibitor added is not preferred from the viewpoint of reagent cost. Thus, the amount of the scale inhibitor added is preferably 5 to 50 times the weight of the concentration of calcium ions in the softened water.

An alkali is added to the water to which the scale inhibitor has been added, to adjust the pH of the water (RO feed water) fed into the subsequent RO membrane separator 7 to 9.5 or more, preferably 10 or more, more preferably 10.5 to 12, and, for example, 10.5 to 11. As the alkali used here, an inorganic alkaline agent, e.g., sodium hydroxide or potassium hydroxide, may be used without limitation so long as it can adjust the pH of the RO feed water to 9.5 or more.

In the present invention, the addition of the scale inhibitor and the alkali may be performed between the softening column 8 and the RO membrane separator 7 without limitation. Any order of addition of these agents may be used. To completely inhibit the development of microorganisms in the system and completely inhibit the formation of scale in the system, preferably, after the addition of the scale inhibitor, the alkali is added to adjust the pH of the RO feed water to 9.5 or more.

In the present invention, a reducing agent may be optionally used to decompose and remove the remaining combined-chlorine-based oxidizer by subjecting the combined-chlorine-based oxidizer to reduction treatment. As the reducing agent used here, any reducing agent may be used without limitation so long as the reducing agent such as sodium hydrogen sulfite can remove the combined-chlorine-based oxidizer. The reducing agent may be used alone or in combination of two or more as a mixture. The amount of the reducing agent added may be an amount such that the remaining combined-chlorine-based oxidizer is completely removed. The reducing agent is usually added on the entry side of the softening column 8.

Examples of the RO membrane of the RO membrane separator 7 to which the pretreated water is fed include alkali-resistant membranes, such as polyether amide composite membranes, polyvinyl alcohol composite membranes, and aromatic polyamide membranes. It is preferred to use a polyvinyl alcohol-based low-fouling RO membrane having desalination performance in which a salt rejection rate (hereinafter, simply referred to as “salt rejection rate”) is 95% or more when 1500 mg/L saline with a pH of 7 is subjected to RO membrane separation treatment at 1.47 MPa and 25° C. The reason such a low-fouling RO membrane is preferably used is described below.

That is, surfaces of the low-fouling RO membrane are not charged and have hydrophilicity. Thus, the low-fouling RO membrane has excellent stain resistance compared with that of a commonly used aromatic polyamide membrane. However, the effect of stain resistance is reduced for water containing a large amount of a nonionic surfactant, thus reducing the flux with time.

The nonionic surfactant that can reduce the flux through the RO membrane is detached from the membrane by adjusting the pH of the RO feed water to 9.5 or more. It is thus possible to prevent an extreme reduction in flux even if a commonly used aromatic polyamide membrane is used. However, at a high concentration of the nonionic surfactant in the RO feed water, the effect is reduced, thereby reducing the flux in the longer term.

In the present invention, to overcome the foregoing problems, preferably, the polyvinyl alcohol-based low-fouling RO membrane having the foregoing specific desalination performance is combined with the condition in which RO feed water with a pH of 9.5 or more is passed, so that it is possible to provide stable operation even for RO feed water containing a high concentration of a nonionic surfactant over long periods of time without causing a reduction in flux.

Any type of RO membrane, e.g., a spiral-shaped membrane, a hollow-fiber membrane, or tube-shaped membrane, may be used.

An acid is then added to water that has been passed through the RO membrane separator 7 (hereinafter, also referred to as “RO-treated water”) to adjust the pH to 4 to 8. Treatment with activated carbon is performed, as needed. The water is recycled or released. The acid used here is not particularly limited. Examples thereof include mineral acids such as hydrochloric acid and sulfuric acid.

Meanwhile, concentrated water from the RO membrane separator 7 (hereinafter, also referred to as “RO-concentrated water”) is discharged outside the system and treated.

FIGS. 1 and 2 show exemplary embodiments of the present invention. The present invention is not limited to the configurations shown in the figures so long as the present invention does not depart from the subject matter. For example, the treatment with the RO membrane separator is not limited to the single-stage treatment but may be two-or-more stage treatment, i.e., multistage treatment. Furthermore, a mixing tank used for the adjustment of the pH and the addition of the scale inhibitor and so forth may be arranged.

### EXAMPLES

The present invention will be described in more detail below by examples, comparative examples, and reference examples.

### Example and Comparative Example of Embodiment Illustrated in FIG. 1

### Example 1

Chloramine T was added to industrial water with a TOC concentration of 1 mg/L as C in such a manner that the concentration of combined chlorine was 5 mg-Cl₂/L. Next, coagulation-filtration treatment was performed under conditions in which the amount of polyaluminum chloride (PAC) added was 10 mg/L and the pH was 6. The water that had been subjected to the coagulation-filtration treatment was passed through an activated carbon column at an SV of 20 hr⁻¹. Then the water was passed through an RO membrane separator (with an aromatic-polyamide ultra-low-pressure RO membrane “ES-20”, manufactured by Nitto Denko Corporation) at a permeate flow of 60 L/hr and a recovery rate of 80%. The RO feed water had a pH of 5.5.

### Comparative Example 1

Treatment was performed under the same conditions as those in Example 1, except that NaClO in place of chloramine T was added to industrial water with a TOC concentration of 1 mg/L as C in such a manner that the concentration of free chlorine was 0.5 mg-Cl₂/L.

### Examples 2 to 5

Treatment was performed under the same conditions as those in Example 1, except that chloramine T was added to the industrial water with a TOC concentration of 1 mg/L as C in such a manner that the concentration of combined chlorine was 0.5 mg-Cl₂/L (Example 2), 0.8 mg-Cl₂/L (Example 3), 1 mg-Cl₂/L (Example 4), or 3 mg-Cl₂/L (Example 5).

### Examples 6 to 9

Treatment was performed under the same conditions as those in Example 1, except that after chloramine T was added to the industrial water with a TOC concentration of 1 mg/L as C in such a manner that the concentration of combined chlorine was 1 mg-Cl₂/L, coagulation-filtration treatment was performed under conditions in which the amount of PAC added was 10 mg/L and the pH was 6, and then the water that had been subjected to the coagulation-filtration treatment was passed through activated carbon at an SV of 10 hr⁻¹ (Example 6), 15 hr⁻¹ (Example 7), 20 hr⁻¹ (Example 8), or 30 hr⁻¹ (Example 9).

### <Evaluation of Effect of Inhibiting Growth of Viable Cell>

In Example 1 and Comparative Example 1, viable cell counts were measured at several points. Table 1 shows the results.

TABLE 1

| | | Comparative |
|---|---|---|
| | Example 1 | Example 1 |
| Germicide used | Chloramine T | NaClO |
| Activated carbon | ND | ND |
| feed water | | |
| Activated | ND | 5 × 10³ cells/ml |
| carbon-treated water | | |
| RO feed water | ND | 4 × 10³ cells/ml |
| RO-concentrated | ND | 2 × 10⁵ cells/ml |
| water | | |
| RO-treated water | ND | ND |

As is clear from Table 1, in Example 1 in which chloramine T serving as a combined-chlorine-based oxidizer was used, no viable cells were detected at all measuring points. In contrast, in Comparative Example 1, 10³ viable cells per milliliter were detected in the activated carbon-treated water. The results demonstrate that a conventionally used germicide cannot inhibit the growth of slime at stages subsequent to the activated carbon column.

### <Evaluation of Effect of Suppressing Increase in Differential Pressure Across RO Membrane>

In Example 1 and Comparative Example 1, daily changes in differential pressure across the RO membrane separator were measured. Table 3 shows the results.

As is clear from FIG. 3, in Example 1, no increase in differential pressure across the RO membrane separator was observed. In contrast, in Comparative Example 1, the differential pressure reached about 0.4 MPa about 7 months after the start of passing water. The adhesion of slime to the clogged RO membrane separator was observed.

<Relationship between Concentration of Combined Chlorine and Effect of Inhibiting Growth of Viable Cell>

In Examples 2 to 5, concentrations of combined chlorine in activated carbon feed water (water fed into the activated carbon column) and activated carbon-treated water (water from the activated carbon column) were measured, and viable cell counts in the activated carbon-treated water were measured. Table 2 shows the results.

TABLE 2

| | Example 2 | | Example 3 | | Example 4 | | Example 5 | |
|---|---|---|---|---|---|---|---|---|
| Concentration of | 0.5 | mg/L | 0.8 | mg/L | 1 | mg/L | 3 | mg/L |
| combined chlorine | | | | | | | | |
| in activated carbon feed | | | | | | | | |
| water | | | | | | | | |

| | | | | | | |
|---|---|---|---|---|---|---|
| Concentration of | ND | ND | 0.5 | mg/L | 2 | mg/L |
| combined chlorine | | | | | | |
| in activated carbon-treated | | | | | | |
| water | | | | | | |

| | | | | | | |
|---|---|---|---|---|---|---|
| Viable cell count in | 4 × 10³ | cells/ml | 5 × 10³ | cells/ml | ND | ND |
| activated carbon-treated | | | | | | |
| water | | | | | | |

As is clear from Table 2, at a concentration of combined chlorine in the activated carbon feed water of 1 mg-Cl₂/L or more, no viable cells were detected in the activated carbon-treated water.

### <Relationship Between SV of Water Through Activated Carbon Column and Effect of Inhibiting Growth of Viable Cell>

In Examples 6 to 9, concentrations of combined chlorine and viable cell counts in the activated carbon-treated water were measured. Table 3 shows the results.

TABLE 3

| | Example 6 | | Example 7 | | Example 8 | | Example 9 | |
|---|---|---|---|---|---|---|---|---|
| SV of water | 10 | hr⁻¹ | 15 | hr⁻¹ | 20 | hr⁻¹ | 30 | hr⁻¹ |
| through | | | | | | | | |
| activated carbon column | | | | | | | | |

| | | | | | | |
|---|---|---|---|---|---|---|
| Concentration of | ND | ND | 0.5 | mg/L | 0.9 | mg/L |
| combined chlorine in | | | | | | |
| activated carbon-treated | | | | | | |
| water | | | | | | |

| | | | | | | |
|---|---|---|---|---|---|---|
| Viable cell | 9 × 10³ | cells/mil | 2 × 10³ | cells/mil | ND | ND |
| count in | | | | | | |
| activated carbon-treated | | | | | | |
| water | | | | | | |

As is clear from Table 3, at an SV of water passing through the activated carbon column of 20 hr⁻¹ or more, no viable cells were detected in the activated carbon-treated water.

The above-described results demonstrate that the requirements for the inhibition of the growth of slime in the activated carbon column are as follows: a concentration of combined chlorine in the activated carbon feed water of 1 mg/L or more, and an SV of water passing through the activated carbon column of 20 hr⁻¹ or more.

### Example, Comparative Example, and Reference Example of Embodiment Illustrated in FIG. 2

### Example 10

Chloramine T was added to wastewater containing a nonionic surfactant and having a TOC concentration of 20 mg/L and a calcium concentration of 5 mg/L in such a manner that the concentration of combined chlorine was 5 mg-Cl₂/L. Next, coagulation-filtration treatment was performed under conditions in which the amount of polyaluminum chloride (PAC) added was 20 mg/L and the pH was 6.5. The water that had been subjected to the coagulation-filtration treatment was passed through a fixed-bed activated carbon column at an SV of 20 hr⁻¹ and then a softening column at an SV of 15 hr⁻¹. Next, an EDTA-based scale inhibitor (Welclean A801, manufactured by Kurita Water Industries Ltd.) was added in an amount of 10 mg/L (five times the weight of the concentration of calcium ions in softening column-treated water). NaOH was added to adjust the pH to 10.5. Then the water was passed through an RO membrane separator (with an aromatic-polyamide ultra-low-pressure RO membrane “ES-20”, manufactured by Nitto Denko Corporation) at a permeate flow of 60 L/hr and a recovery rate of 80% to perform RO membrane separation treatment. The RO feed water had a pH of 9.5.

### Comparative Example 2

Treatment was performed under the same conditions as those in Example 10, except that NaClO in place of chloramine T was added to the wastewater containing a nonionic surfactant and having a TOC concentration of 20 mg/L and a calcium concentration of 5 mg/L in such a manner that the concentration of free chlorine was 0.5 mg-Cl₂/L.

### Examples 11 to 14

Treatment was performed under the same conditions as those in Example 10, except that chloramine T was added to the wastewater containing a nonionic surfactant and having a TOC concentration of 20 mg/L and a calcium concentration of 5 mg/L in such a manner that the concentration of combined chlorine was 0.5 mg-Cl₂/L (Example 11), 0.8 mg-Cl₂/L (Example 12), 1 mg-Cl₂/L (Example 13), or 3 mg-Cl₂/L (Example 14).

### Examples 15 to 18

Treatment was performed under the same conditions as those in Example 10, except that after chloramine T was added to the wastewater containing a nonionic surfactant and having a TOC concentration of 20 mg/L and a calcium concentration of 5 mg/L in such a manner that the concentration of combined chlorine was 1 mg-Cl₂/L, coagulation-filtration treatment was performed under conditions in which the amount of PAC added was 20 mg/L and the pH was 6.5, and then the water that had been subjected to the coagulation-filtration treatment was passed through a fixed-bed activated carbon column at an SV of 10 hr⁻¹ (Example 15), 15 hr⁻¹ (Example 16), 20 hr⁻¹ (Example 17), or 30 hr⁻¹ (Example 18).

### Reference Examples 1 and 2

Treatment was performed under the same conditions as those in Example 10, except that the pH of the softening column-treated water was adjusted in such a manner that the pH of the RO feed water was 6 (Reference Example 1) or 8.5 (Reference Example 2).

### <Evaluation of Effect of Inhibiting Growth of Viable Cell>

In Example 10 and Comparative Example 2, viable cell counts were measured at several points. Table 4 shows the results.

TABLE 4

| | | Comparative |
|---|---|---|
| | Example 10 | Example 2 |
| Germicide used | Chloramine T | NaClO |
| Activated carbon | ND | ND |
| feed water | | |
| Activated | ND | 10⁵ cells/ml |
| carbon-treated water | | |
| Softened water | ND | 10⁶ cells/ml |
| RO feed water | ND | ND |
| RO-concentrated water | ND | ND |
| RO-treated water | ND | ND |

As is clear from Table 4, in Example 10 in which chloramine T serving as a combined-chlorine-based oxidizer was used, no viable cells were detected at all measuring points. In contrast, in Comparative Example 2, 10⁵ viable cells per milliliter were detected in the activated carbon-treated water, and 10⁶ viable cells per milliliter were detected in the softening column-treated water (sampled before the addition of the alkali). The results demonstrate that a conventionally used germicide cannot inhibit the growth of slime at stages subsequent to the activated carbon column.

### <Evaluation of Effect of Suppressing Increase in Differential Pressure Across RO Membrane>

In Example 10, Comparative Example 2, and Reference Examples 1 and 2, daily changes in flux through the RO membrane separator were measured. Table 5 shows the results.

TABLE 5

Flux (m³/m² · day)

| Number | Example | Comparative | Reference | Reference |
|---|---|---|---|---|
| of day | 10 | Example 2 | Example 1 | Example 2 |
| 1 | 1.0 | 0.98 | 0.98 | 0.99 |
| 7 | 0.95 | 0.96 | 0.98 | 0.97 |
| 30 | 0.95 | 0.5 | 0.97 | 0.97 |
| 60 | 0.93 | — | 0.7 | 0.68 |
| 90 | 0.93 | — | 0.4 | 0.42 |

As is clear from Table 5, in Example 10, no reduction in flux through the RO membrane separator was observed. In contrast, in Comparative Example 2, the flux reached about 0.5 m³/m²·day after 30 days. Slime was detected on the clogged RO membrane. In Reference Examples 1 and 2, no reduction in flux was observed until 30 days after the start of passing water. However, the flux was reduced to about 0.7 m³/m²·day after 60 days and about 0.4 m³/m²·day after 90 days. No trace of slime was detected on the clogged membranes, and no increase in differential pressure across modules was observed. The results suggested clogging due to the surfactant.

The results demonstrate that the use of the combined-chlorine-based oxidizer and a pH of the RO feed water of 9.5 or more are effective in preventing the reduction in flux through the RO membrane separator.

### <Relationship Between Amount of Combined-Chlorine-Based Oxidizer Added and Effect of Inhibiting Growth of Viable Cell>

In Examples 11 to 14, viable cell counts in the activated carbon-treated water and the softened water were measured. Table 6 shows the results.

TABLE 6

| | Example 11 | | Example 12 | | Example 13 | Example 14 |
|---|---|---|---|---|---|---|
| Amount of | 0.5 | mg-Cl₂/L | 0.8 | mg-Cl₂/L | 1 mg-Cl₂/L | 3 mg-Cl₂/L |
| chloramine T added | | | | | | |
| (concentration of | | | | | | |
| combined chlorine) | | | | | | |
| Activated | 3 × 10⁴ | cells/ml | 6 × 10³ | cells/ml | ND | ND |
| carbon-treated | | | | | | |
| water | | | | | | |
| Softened water | 4 × 10⁵ | cells/ml | 8 × 10⁴ | cells/ml | ND | ND |

Table 6 shows that in order to surely inhibit the growth of viable cells, the combined-chlorine-based oxidizer is preferably added in such a manner that the concentration of combined chlorine in the activated carbon feed water is 1 mg-Cl₂/L or more.

### <Relationship Between SV of Water Through Activated Carbon Column and Effect of Inhibiting Growth of Viable Cell>

In Examples 15 to 18, viable cell counts in the activated carbon-treated water and the softening column-treated water were measured. Table 7 shows the results.

TABLE 7

| | Example 15 | | Example 16 | | Example 17 | Example 18 |
|---|---|---|---|---|---|---|
| SV of water | 10 | hr⁻¹ | 15 | hr⁻¹ | 20 hr⁻¹ | 30 hr⁻¹ |
| through | | | | | | |
| activated carbon column | | | | | | |
| Activated | 9 × 10⁴ | cells/ml | 2 × 10⁵ | cells/ml | ND | ND |
| carbon-treated water | | | | | | |
| Softened water | 2 × 10⁶ | cells/ml | 7 × 10⁶ | cells/ml | ND | ND |

Table 7 shows that in order to surely inhibit the growth of viable cells, the SV of water passing through the activated carbon column is preferably set to 20 hr⁻¹ or more.

The present application contains subject matter related to that disclosed in Japanese Priority Patent Application JP 2007-222758 filed in the Japan Patent Office on Aug. 29, 2007, the entire content of which is hereby incorporated by reference.

1. A method for treating organic matter-containing water, comprising:
an oxidizer addition step of adding an oxidizer to organic matter-containing water;
an activated carbon treatment step of treating the organic matter-containing water that has been subjected to the oxidizer addition step with activated carbon; and
a reverse osmosis membrane separation step of feeding the organic matter-containing water that has been subjected to the activated carbon treatment step into a reverse osmosis separation means,
wherein a combined-chlorine-based oxidizer is used as the oxidizer.

2. The method for treating organic matter-containing water according to claim 1, wherein in the oxidizer addition step, the combined-chlorine-based oxidizer is added in an amount such that the concentration of combined chlorine is 1 mg-Cl₂/L or more.

3. The method for treating organic matter-containing water according to claim 1, wherein in the activated carbon treatment step, the organic matter-containing water is fed into an activated carbon column at an SV of 20 hr⁻¹ or more.

4. The method for treating organic matter-containing water according to claim 1, further comprising:
a hardness component removal step of feeding the organic matter-containing water that has been subjected to the activated carbon treatment step into a cation exchange means to reduce the hardness;
a scale inhibitor addition step of adding a scale inhibitor to the organic matter-containing water that has been subjected to the hardness component removal step, the amount of the scale inhibitor added being five or more times the weight of calcium ions in the organic matter-containing water that has been subjected to the hardness component removal step; and
a pH adjustment step of adding an alkali to the organic matter-containing water to adjust the pH of the organic matter-containing water to be fed into a subsequent reverse osmosis membrane separation means to 9.5 or more before, after, or simultaneously with the scale inhibitor addition step.

5. An apparatus for treating organic matter-containing water, comprising:
an oxidizer addition means configured to add an oxidizer to organic matter-containing water;
an activated carbon treatment means configured to treat the organic matter-containing water that has been passed through the oxidizer addition means with activated carbon; and
a reverse osmosis membrane separation means configured to subject the organic matter-containing water that has been passed through the activated carbon treatment means to reverse osmosis membrane separation treatment,
wherein a combined-chlorine-based oxidizer is used as the oxidizer.

6. The apparatus for treating organic matter-containing water according to claim 5, wherein in the oxidizer addition means, the combined-chlorine-based oxidizer is added in an amount such that the concentration of combined chlorine is 1 mg-Cl₂/L or more.

7. The apparatus for treating organic matter-containing water according to claim 5, wherein the activated carbon treatment means is an activated carbon column, and the SV of water passing through the activated carbon column is 20 hr⁻¹ or more.

8. The apparatus for treating organic matter-containing water according to claim 5, further comprising:
a hardness component removal means including a cation exchange means through which the organic matter-containing water that has been passed through the activated carbon treatment means is passed;
a scale inhibitor addition means configured to add a scale inhibitor to the organic matter-containing water that has been passed through the hardness component removal means, the amount of the scale inhibitor added being five or more times the weight of calcium ions in the organic matter-containing water that has been passed through the hardness component removal means; and
a pH adjustment means configured to add an alkali to the organic matter-containing water to adjust the pH of the organic matter-containing water to be fed into a subsequent reverse osmosis membrane separation means to 9.5 or more before, after, or simultaneously with the scale inhibitor addition means.
